(19) United States
(12) Patent Application Publication
(10) Pub. No.: US 2026/0103388 A1
(43) Pub. Date: Apr. 16, 2026

(54) SYNTHESIS OF AN ALUMINUM-CONTAINING MOLECULAR SIEVE WITH A CIT-15 FRAMEWORK STRUCTURE

(71) Applicant: CHEVRON U.S.A. INC., San Ramon, CA (US)

(72) Inventors: Stacey Ian ZONES, San Francisco, CA (US); Cong-Yan CHEN, Kensington, CA (US)

(21) Appl. No.: 19/356,844

(22) Filed: Oct. 13, 2025

Related U.S. Application Data
(60) Provisional application No. 63/707,920, filed on Oct. 16, 2024.

(51) Int. Cl. C01B 39/46

(52) U.S. Cl. CPC C01B 39/46; C01P 2002/72; C01P 2006/14

(57) ABSTRACT

A process is provided for the synthesis of an aluminum-containing molecular sieve having a CIT-15 framework structure. The process includes treating an aluminum-containing molecular sieve having a CIT-13 framework structure under basic conditions to delaminate at least a portion of the molecular sieve to provide a phyllosilicate comprising delaminated cfi-layers, treating the phyllosilicate with a C6-C12 alkylamine, and calcining the treated phyllosilicate under conditions sufficient to convert the phyllosilicate to an aluminum-containing molecular sieve having the CIT-15 framework structure.

### RELATED APPLICATIONS

The present application claims priority to U.S. Provisional Patent Application No. 63/707,920 filed Oct. 16, 2024, the entire content of which is incorporated herein by reference.

### TECHNICAL FIELD

The present disclosure relates to a process of synthesizing an aluminum-containing molecular sieve having a CIT-15 framework structure and to an aluminum-containing molecular sieve having a CIT-15 framework structure obtainable by the process.

### BACKGROUND

Molecular sieves are a family of porous materials having a regular inorganic framework structure with a plurality of pores or channels of set size that are defined therein. The pore or channel size varies for different molecular sieves and determines the breadth of molecules that may enter the interior of a particular molecular sieve. Because of their microporosity of defined size and the molecular specificity gained therefrom, molecular sieves often find utility in adsorption, ion-exchange, gas separation, and catalyst applications. Various molecular sieve framework structures recognized by the Structure Commission of the International Zeolite Association are maintained in a structural database accessible at https://www.iva-structure.org/databases/.

The idealized inorganic framework structure of molecular sieves is a framework silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, germanium, or metals (e.g., transition metals, such as titanium, iron, or zinc). Atoms other than silicon and oxygen in the framework silicate occupy a portion of the lattice sites otherwise occupied by silicon atoms in an “all-silica” framework silicate. Thus, the term “framework silicate”, as used herein, refers to an atomic lattice comprising any of a silicate, borosilicate, aluminosilicate, germanosilicate, titanosilicate, ferrisilicate, zincosilicate, or the like.

The structure of the framework silicate within a given molecular sieve determines the size of the pores or channels that are present therein. The pore or channel size may determine the types of processes for which a given molecular sieve is applicable. Currently, greater than 200 unique molecular sieve framework silicate structures are known and recognized by the Structure Commission of the International Zeolite Association, thereby defining a range of pore geometries and orientations.

Synthetic molecular sieves are typically prepared via hydrothermal synthesis which involves the use of inorganic (Na⁺, K⁺, etc.) and organic structure-directing agents (OSDAs), mineralizing agents (hydroxide ions or fluoride ions), tetrahedral atom sources (in addition to silicon such as boron, aluminum, germanium, titanium, iron, etc.), etc. The synthesis of a crystalline molecular sieve is complex. While progress is being made on designing certain portions of the recipes and assembly processes, the approach makes it difficult to predict outcomes.

The topotactic transformation of existing zeolites offers a way to prepare new zeolitic frameworks that have never been synthesized by conventional hydrothermal methods. Topotactic transformation is a specific type of structural change whereby a molecular sieve framework rearranges into a new structure while maintaining some degree of structural continuity. This process often involves altering the connectivity of the tetrahedral building units while preserving some structural elements of the original framework. One example is the assembly-disassembly-organization-reassembly (ADOR) strategy. This synthetic route takes advantage of the assembly of a relatively poorly stable molecular sieve material which can be selectively disassembled into a layered material. The resulting layered intermediate can then be organized in different manners by selective chemical manipulation and then reassembled into molecular sieves with new framework structures.

Germanosilicate molecular sieve have attracted considerable attention in recent years due to their easily modifiable structures, resulting from the relatively weak Ge(Si)—O—Ge bonds present in the double-4-ring (d4r) units of these molecular sieves, as they are potential precursors for the post-synthesis of a number of novel molecular sieve structures that are difficult to generate by direct hydrothermal synthesis. The ADOR strategy has proven to be effective in selectively removing interlayer germania-rich d4r units and converting the three-dimensional (3D) germanosilicates into two-dimensional (2D) layered intermediates, followed by reconstruction to yield one or more daughter structures.

CIT-13 is a germanosilicate molecular sieve with a unique two-dimensional pore system characterized by intersecting 14- and 10-membered ring pores. CIT-13 has a disordered framework structure which consists of silica-rich cfi-layers interconnected via germania-rich d4r units to form 10- and 14-membered ring channels between the layers. Since the framework germanium is located primarily in the d4r units of the molecular sieve, CIT-13 is an attractive starting material for transformations via the ADOR strategy.

For example, X. Liu et al. (Chem. Eur. J. 2019, 25, 1-11) reported the systematic removal of the randomly arranged d4r units in germanosilicate CIT-13 by a mild alkaline treatment, eliminating the intergrowth structure of CIT-13 to provide a layered intermediate designated ECNU-21P and the subsequent conversion of the layered intermediate by calcination into a germanosilicate single-crystalline structure designated ECNU-21 (EWO framework topology and isostructural with CIT-15 and IPC-15 molecular sieves), a molecular sieve material with one-dimensional 10-membered ring channels. Due to their unique shape-selective properties, molecular sieves with one-dimensional 10-membered ring channels have proven to be valuable catalysts in various industrial processes, such as isomerization of n-alkanes.

For catalytic applications, incorporation of catalytic active sites is important to impart acidic properties to a molecular sieve. Catalytically active molecular sieves can be obtained by substitution of a trivalent metal, such as aluminum, for silicon in the silicate framework of the molecular sieve. Each substitution creates a negative charge on the lattice, which is compensated by a proton or cation. When the negative charge is compensated by a proton, an acidic bridging hydroxyl group (Brønsted acid site) is created. The acidity of molecular sieves is directly related to the amount and siting of aluminum incorporated into the framework.

There remains a need for processes for preparing aluminum-containing CIT-15 molecular sieves, particularly processes which could provide materials with improved catalytic activities.

### SUMMARY

The present disclosure relates to aluminum-containing molecular sieve having a CIT-15 framework structure, processes of making the same, and uses thereof.

In a first aspect, the present disclosure relates to a process for preparing an aluminum-containing molecular having a CIT-15 framework structure, the process comprising: providing a molecular sieve having a CIT-13 framework structure, wherein the framework structure comprises Al₂O₃, GeO₂ and SiO₂, wherein the molecular sieve has a molar ratio of GeO₂:SiO₂ of from 3.8:1 to 5.68:1, the molecular sieve characterized by a three-dimensional framework of silica-rich cfi-layers interconnected by germania-rich double-4-ring (d4r) units and having pores defined by 14- and 10-membered rings; (ii) treating the molecular sieve provided in (i) with a basic aqueous solution, the treating resulting in delamination of the molecular sieve thereby obtaining an aluminum-containing phyllosilicate comprising delaminated silica-rich cfi-layers, wherein the phyllosilicate has a molar ratio of GeO₂:SiO₂ of least 40:1, and at least partially separating the phyllosilicate from the basic aqueous solution; (iii) treating the separated aluminum-containing phyllosilicate obtained in (ii) with a C6-C12 alkylamine thereby obtaining an amine-treated aluminum-containing phyllosilicate, and at least partially separating the amine-treated aluminum-containing phyllosilicate from the alkylamine; and (iv) calcining the amine-treated aluminum-containing phyllosilicate obtained in (iii) at a temperature, and for a time, sufficient to form an aluminum-containing molecular sieve having a CIT-15 framework structure, wherein the framework structure comprises Al₂O₃ and SiO₂, the molecular sieve characterized by a three-dimensional framework having pores defined by 10-membered rings.

In a second aspect, the present disclosure relates to an aluminum-containing molecular sieve having a CIT-15 framework structure which is characterized by one or more of: (1) a SiO₂:Al₂O₃ molar ratio of 50:1 to 500:1; (2) a SiO₂:GeO₂ molar ratio of at least 40:1; (3) a total acid site density of 45 to 75 mmol/g; (4) a micropore volume of 0.031 to 0.050 cm³/g.

In a third aspect, the present disclosure relates to a process of converting an organic compound to a conversion product, which comprises contacting the organic compound with the aluminum-containing molecular sieve material according to the second aspect or prepared according to the process of the first aspect.

### BRIEF DESCRIPTION OF THE DRAWINGS

FIG. 1 shows an illustrative scheme of some of the transformations discussed in this disclosure.

FIG. 2 shows a powder X-ray diffraction (XRD) pattern of the phyllosilicate material as obtained according to Example 2.

FIG. 3 shows a powder XRD pattern of the aluminum-containing Al-CIT-15 material as obtained according to Example 3.

### DETAILED DESCRIPTION

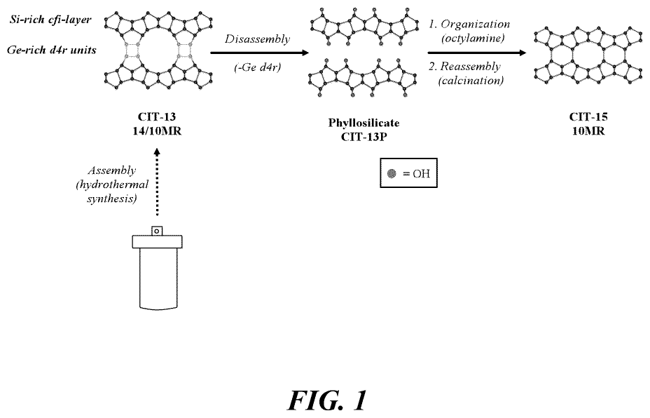

It is an object of the present disclosure to provide an improved process for the synthesis of aluminum-containing molecular sieves having a CIT-15 framework structure. It is also an object of the present disclosure to provide an aluminum-containing molecular sieve having a CIT-15 framework structure with new and improved physical and chemical properties. FIG. 1 shows an illustrative scheme of some of the transformations discussed in this disclosure.

As used in this disclosure, the term “molecular sieve” refers to a crystalline microporous material that that comprises a three-dimensional framework of oxide tetrahedra.

As used in this disclosure, the term “phyllosilicate” refers to a 2-dimensional layered structure of silica-containing oxides.

As used in this disclosure, the term “CIT-13” encompasses all molecular sieve materials of the “intergrowth family CIT-13” as defined by the International Zeolite Association Structure Commission (IZA-SC). Molecular sieve materials designated by the IZA-SC as being of the “intergrowth family CIT-13” include CIT-13, NUD-2 and SAZ-1.

As used in this disclosure, the term “germania-rich” refers to compositions having sufficient germanium to favor a delamination as described below. Generally, such delaminations occur with materials having SiO₂:GeO₂ molar ratios of less than 6:1, 5.6:1, 5.4:1, 5:1, 4.4:1, or 4.35:1. When used in the context of the d4r composite building unit (e.g., “germania-rich d4r units”), the germanium content is much higher, and the SiO₂/GeO₂ molar ratios can approach or be practically zero (i.e., these units are practically entirely germanium oxides). By contrast, when used in the context of an overall composition, the term “silica-rich” refers to a composition which is not prone to delamination, presumably because the silicon content in the joining units is too refractory.

As used in this disclosure, the terms “calcination” and “calcining” refer to heating a material to a temperature of 350° C. or more under any atmosphere, e.g., an oxidizing atmosphere, an inert atmosphere, or a reducing atmosphere.

### Step (i)

According to step (i) of the process of the present disclosure, a molecular sieve is provided having a CIT-13 framework structure comprising Al₂O₃, GeO₂ and SiO₂, referred to herein as aluminum-containing CIT-13 or Al-CIT-13.

There are no specific restrictions how the aluminum-containing CIT-13 molecular sieve is provided. The molecular sieve may be either purchased from a commercial source or prepared according to a suitable synthetic process known in the art. Methods for preparing aluminum-containing CIT-13 are known in the art and are described, for example, in U.S. Pat. Nos. 10,155,666 and 10,828,625 and U.S. Patent Appl. Pub. No. 2023/0357030. The aluminum-containing CIT-13 molecular sieve may be provided in the form of a powder or in the form of a spray powder or a spray granulate.

Generally, the framework structure of the molecular sieve material provided in (i) comprises Al₂O₃, GeO₂ and SiO₂. Preferably, the suitable sources of Al₂O₃, GeO₂ and SiO₂ are employed in an amount that at least 90 wt. %, at least 95 wt. %, at least 98 wt. %, or at least 99 wt. % of the framework structure of the molecular sieve material provided in (i) consists of Al₂O₃, GeO₂ and SiO₂.

Generally, the aluminum-containing molecular sieve material having a CIT-13 framework structure can have a SiO₂:Al₂O₃ molar ratio of 50:1 to 500:1, alternatively 60:1 to 400:1, or alternatively 80:1 to 350:1. In some aspects, the aluminum-containing molecular sieve material having a CIT-13 framework structure can have a SiO₂:GeO₂ molar ratio of SiO₂:GeO₂ from 3.8:1 to about 4.5:1, 5.0:1, 5.4:, or even 5.68:1.

### Step (ii)

According to step (ii) of the process of the present disclosure, the aluminum-containing CIT-13 molecular sieve obtained from (i) is treated with a basic aqueous solution, wherefrom an aluminum-containing phyllosilicate material comprising delaminated silica-rich cfi-layers and having a SiO₂:GeO₂ molar ratio of at least 40 is obtained, and wherein the aluminum-containing phyllosilicate material (designated CIT-13P herein) is at least partially separated from the basic aqueous mixture.

In various aspects, the basic aqueous solution comprises a base. Any base suitable for providing a pH in the desired range may be employed. Exemplary bases include ammonia, ammonium hydroxide, tetraalkylammonium hydroxides (e.g., tetramethylammonium hydroxide, tetraethylammonium hydroxide, tetrapropylammonium hydroxide, tetrabutylammonium hydroxide), organic amines, alkali metal hydroxides (e.g., sodium hydroxide, potassium hydroxide, lithium hydroxide), and mixtures of two or more thereof. In certain aspects, the base comprises ammonium hydroxide.

In some aspects, in (ii), the basic aqueous solution has a pH in the range of from 8 to 14, alternatively from 8 to 13, alternatively from 8 to 12, alternatively from 9 to 14, alternatively from 9 to 13, alternatively from 9 to 12, alternatively from 10 to 14, alternatively from 10 to 13, or alternatively from 10 to 12.

Concerning the temperature according to (ii), no specific restrictions exist. Preferably, the treating according to (ii) is carried out at a temperature of 35° C. to 110° C., alternatively 40° C. to 100° C. or alternatively 35° C. to 80° C.

Concerning the time period of the treating with the basic aqueous solution according to (ii), no specific restrictions exist. Preferably, in (ii), the aluminum-containing CIT-13 molecular sieve material is treated with the basic aqueous solution for a time period of 1 to 72 hours, alternatively 6 to 72 hours, alternatively 6 to 48 hours, or alternatively 12 to 30 hours.

As far as the amount of the basic aqueous solution used in (ii) is concerned, no specific restrictions exist. In some aspects, the weight ratio of the basic aqueous solution relative to the aluminum-containing CIT-13 molecular sieve material is in the range of from 2:1 to 100:1, alternatively from 5:1 to 50:1, or alternatively from 10:1 to 35:1.

In (ii), the treating with the basic aqueous solution may be carried out in an open system or in a closed system. Preferably, the treating in (ii) is carried out in a closed system (e.g., an autoclave) under autogenous pressure.

During the treating according to (ii), it is preferred to suitably stir the basic aqueous solution containing the molecular sieve material. During (ii), the stirring rate is kept essentially constant or changed. The stirring rate as such can be suitably chosen depending, for example, on the volume of the basic aqueous solution, the amount of the molecular sieve material employed, the desired temperature, and the like. Preferably, the stirring rate under which the treating at the above-described temperatures is carried out is preferably in the range of 50 to 1000 rpm, alternatively 200 to 800 rpm.

After the treating according to (ii), the obtained aluminum-containing phyllosilicate is suitably at least partially separated from the basic aqueous solution by a solid/liquid separation. All methods of separating the phyllosilicate from the respective suspension are conceivable. These methods include filtration, ultrafiltration, diafiltration and centrifugation methods. A combination of two or more of these methods can be applied. According to the present disclosure, the phyllosilicate is preferably separated from the suspension by filtration. Preferably, a filter cake is obtained which is preferably subjected to washing, preferably with water. If washing is applied, it may be preferred to continue the washing process until the washing water has a conductivity of at most 500 mS/cm, preferably of at most 200 mS/cm.

After separation of the phyllosilicate from the basic aqueous solution, preferably by filtration, and preferably after washing, the washed phyllosilicate is optionally subjected to drying. It is preferred that the drying occurs in a gas atmosphere having a temperature of 50° C. to 150° C., alternatively 75° C. to 125° C., or alternatively 90° C. to 110° C. Preferably, the gas atmosphere comprises oxygen, preferably is air, lean air, or synthetic air. The drying can be carried out in a static oven or in a continuous drying apparatus.

Preferably, after (ii) and before (iii), the phyllosilicate obtained from (ii) is not subjected to a heat treatment in a gas atmosphere having a temperature of at least 450° C., alternatively of at least 400° C., alternatively of at least 350° C., wherein more preferably, the phyllosilicate obtained from (ii) is not subjected to calcination.

The aluminum-containing phyllosilicate obtained in (ii) may be described as structures comprising the silica-rich cfi-layers resulting from the delamination of germania-rich CIT-13 molecular sieve material, in which the germania-rich d4r layers are removed, with the corresponding introduction of surface silanol (Si—OH) groups. The silica-rich cfi-layers of the phyllosilicate comprise surface silanol (Si—OH) groups in at least some of the positions otherwise occupied by the bonded germania or other oxides. The silica-rich cfi-layers are so-called because they are comprised of cfi-composite building units, its name coming from the framework type CFI, of which CIT-5 is a notable example.

In some aspects, the aluminum-containing phyllosilicate obtained in (ii) has a SiO₂/GeO₂ molar ratio of at least 40:1, 50:1, or 100:1 to infinity (i.e., no germanium). The phyllosilicate compositions may also be described in terms of intermediate ratio ranges, for example one or more of the ranges of ratios from about 40:1 to 50:1, from 50:1 to 60:1, from 60:1 to 80.1, from 80:1 to 100:1, from 100:1 to 200:1, and from 200:1 to infinity. In some embodiments, the phyllosilicate may contain residual germania units attached. A SiO₂:GeO₂ molar ratio of about 50:1 to 100:1 indicates the presence of about 1-2% Ge.

The aluminum-containing phyllosilicate obtained in (ii) can be characterized by a major peak in the powder XRD pattern in a range of from about 6.9 to about 9 degrees 2-0. In other aspects, the major peak in the powder XRD pattern is a peak in a range of from about 7.0±0.2 degrees 2-θ to about 8.1±0.2 degrees 2-θ. This major peak is at a higher angle than the corresponding major peak in the CIT-13 molecular sieve material from which it is derived and is consistent with the removal of the d4r units and the closer pack stacking of the stacked silica-rich cfi-layers. Some variance is seen in the absolute position of this major peak This can be explained when one appreciates that the peak is attributable to stacked individual layers, i.e., each layer is insufficient to provide a diffraction pattern, and it is only by stacking multiple phyllosilicate layers that a diffraction pattern can be seen. In this case, the stacking appears to be extremely sensitive to trace intercalant impurities which may exist between the phyllosilicate layers (e.g., water), which influences the packing and therefore the location of the diffraction peak. Alternatively, different levels of silanol pendants may affect the stacking distances. In any case, the d-spacing of the stacked layers is in a range of from about 10.5 Å to about 11 S Å.

The aluminum-containing phyllosilicate obtained in (ii) is capable of topotactic rearrangements [(re) organizing and (re) assembling] to form a number of different crystalline microporous structures, such as molecular sieve material CIT-15. The molecular sieve material CIT-15 possesses a three-dimensional framework having pores defined by 10-membered rings. Indeed, the overall transformation of the CIT-13 framework through the phyllosilicate intermediate to the CIT-15 frameworks, while practically retaining the original silica-rich cfi-layers, is consistent with condensation transformations, sometimes referred to as ADOR (Assembly-Disassembly-Organization-Reassembly).

Step (iii)

According to step (iii) of the process of the present disclosure, the aluminum-containing phyllosilicate material obtained from (ii) is treated with a C6-12 alkylamine to provide an amine-treated aluminum-containing phyllosilicate, and wherein the amine-treated aluminum-containing phyllosilicate material is at least partially separated from the alkylamine. Without being bound by theory, it is believed that the alkylamine acts as an organizing agent that orders the layers of the phyllosilicate through non-covalent interactions into an orientation that can easily form a new, highly crystalline material (i.e., molecular sieve material CIT-15).

In one or more embodiments, the C6-C12 alkylamine can include only one amine group. In one or more embodiments, the alkylamine can include one amine group and a linear, branched, or cyclic alkyl group. In one or more embodiments, the alkylamine can be a primary amine, secondary amine, tertiary amine, or cyclic amine. In some embodiments, the alkylamine is selected from the group consisting of triethylamine, dipropylamine, hexylamine, heptylamine, octylamine, nonylamine, decylamine, dodecylamine, and mixtures thereof.

Concerning the duration of the treating according to (iii), no specific restrictions exist. Preferably, in (iii), the treating is carried out for a period of from 1 to 7 days, alternatively from 1 to 5 days, alternatively from 2 to 7 days, or alternatively from preferably from 2 to 5 days. The treating temperature can be in the range of from 50° C. to 125° C., alternatively from 90° C. to 115° C.

As far as the amount of phyllosilicate material which is employed relative to the amount of alkylamine, no specific restrictions exist. Preferably, the weight ratio of phyllosilicate material relative to the alkylamine is in the range of from 1:5 to 1:50, alternatively from 1:10 to 1:35, or alternatively from 1:10 to 1:20.

Preferably, the treating according to (iii) is carried out in a closed system, preferably an autoclave, under autogenous pressure. It is further preferred that in (iii), the treating is carried out under autogenous pressure, preferably in an autoclave, without reflux.

After the treating according to (iii), the obtained treated aluminum-containing phyllosilicate is preferably separated from the alkylamine.

The amine-treated phyllosilicate can be isolated by usual methods, such as filtration, centrifugation, sedimentation and decantation of the supernatant etc., where isolation by sedimentation and decantation is preferred. The filter cake can be further purified by washing with a solvent system comprising one or more organic solvents. In one aspect, the organic solvent can be (or can comprise) diethyl ether.

### Step (iv)

According to the present process, the amine-treated aluminum-containing phyllosilicate obtained in step (iii) is calcined for obtaining an aluminum-containing molecular sieve material having a CIT-15 framework structure.

Concerning the calcining procedure in step (iv), no particular restriction applies, provided that an aluminum-containing molecular sieve material having CIT-15 framework structure is obtained in (iv).

Thus, the calcining may be performed under any suitable conditions, wherein the process is preferably carried out in a gas atmosphere having a temperature in the range of from 350° C. to 900° C., alternatively from 400° C. to 700° C., or alternatively from 450° C. to 650° C. In one aspect, the calcining in step (iv) is carried out at a temperature from 500° C. to 600° C.

In some aspects, the gas atmosphere comprises, alternatively is, one or more of air, lean air, and oxygen, more preferably air.

The calcining in (iv) may be conducted for a time period in the range of from 1 to 10 hours, alternatively from 3 to 6 hours.

As regards the SiO₂:Al₂O₃ molar ratio of the CIT-15 material of the present disclosure, no particular restrictions apply such that the inventive zeolitic material having a CIT-15 framework structure may display any conceivable SiO₂:Al₂O₃ molar ratio. Thus, by way of example, the SiO₂:Al₂O₃ molar ratio of the molecular sieve material having a CIT-15 framework structure may range anywhere from 50:1 to 500:1, alternatively from 50:1 to 200:1, alternatively from 100:1 to 500:1, or alternatively from 100:1 to 200:1.

In some aspects, the aluminum-containing CIT-15 molecular sieve material has a molar ratio of SiO₂:GeO₂ ratio in a range of from 40:1 to infinity (i.e., no germanium). In certain aspects, then, the SiO₂:GeO₂ ratio can be described in terms of one or more ranges of from 50:1 to 100:1, alternatively from 50:1 to 60:1, alternatively from 60:1 to 80:1, alternatively from 80:1 to 100:1, alternatively from 100:1 to 200:1, or alternatively from 200:1 to infinity.

In some aspects, the aluminum-containing molecular sieve material having a CIT-15 framework structure according to the present disclosure has a total amount of acid sites in the range of from 45 to 75 mmol/g, alternatively from 45 to 70 mmol/g, alternatively from 45 to 65 mmol/g alternatively from 45 to 60 mmol/g, alternatively from 50 to 75 mmol/g, alternatively from 50 to 70 mmol/g, alternatively from 50 to 65 mmol/g, or alternatively from 50 to 60 mmol/g. The total amount of acid sites is defined as the total molar amount of desorbed n-propylamine per mass of the molecular sieve material determined according to the temperature programmed desorption of n-proplyamine.

In some aspects, the aluminum-containing molecular sieve material having a CIT-15 framework structure according to the present disclosure has a micropore volume of 0.031, 0.032, 0.033, 0.034, or 0.035 to 0.050, 0.049, 0.048, 0.047, 0.046, or 0.045 cm³/g. The micropore volume can be determined using methods known in the relevant art. For example, the materials can be measured with nitrogen physisorption, and the data can be analyzed by the t-plot method described by B.C. Lippens et al. (“Studies on Pore Systems in Catalysts V. The t Method” J. Catal. 1965, 4, 319-323)

In some aspects, the aluminum-containing molecular sieve material having a CIT-15 framework structure according to the present disclosure may be predominantly in the hydrogen form. As used herein, “predominantly in the hydrogen form” means that, after calcination at least 80% of the cation sites are occupied by hydrogen ions.

In some aspects, the aluminum-containing molecular sieve material having a CIT-15 framework structure may be subjected to loading a promoter metal cation on and/or in the molecular sieve material. Accordingly, the process according to the present invention further comprises (v) loading a promoter metal cation on and/or in the molecular sieve material obtained in step (iv), preferably by ion-exchanging or impregnation, more preferably incipient wetness impregnation.

The promoter metal may be any metal known useful for improving the catalytic activity of molecular sieves in catalyst applications, including for example precious metals such as platinum group metal, Pt and Pd, transition metals and alkali earth metals.

The promoter metal may be loaded on and/or in the molecular sieve material in an amount of 0.1 to 1.0 moles, alternatively 0.15 to 0.8 moles, alternatively 0.2 to 0.75 moles, per mole of aluminum in the molecular sieve material, namely the framework aluminum of the molecular sieve material having a CIT-15 framework structure.

Generally, the molecular sieve material having been loaded with a promoter metal in step (v) may be subjected to a work-up procedure including isolating, optionally washing and drying, and/or to a calcination procedure. Accordingly, step (5) in the process according to the present disclosure optionally further comprises the work-up procedure and/or calcination procedure.

The molecular sieve material having a CIT-15 framework structure according to the present disclosure may be used for any conceivable purpose, including, but not limited to, as adsorbent, for ion-exchange, or as a catalyst and/or as a catalyst component, preferably as a catalyst for organic conversion reactions, preferably in the isomerization of an n-alkane feedstock.

### EXAMPLES

The following examples are intended to illustrate the present invention but are not intended to limit its scope.

### Example 1

### Synthesis of Aluminum-Containing CIT-13 Molecular Sieve

A tared Teflon liner for a 23-mL steel Parr autoclave was charged with 1.95 g of ultrastable Y (USY) zeolite with a SiO₂/Al₂O₃ molar ratio of 500 (available from Tosoh as 390HUA) as a silica source, 0.80 g of GeO₂, 0.04 g of aluminum isopropoxide and 15 mmol of 1,2-dimethyl-3-(3-methylbenzyl) imidazolium hydroxide. The mixture was then set in a fume hood to evaporate enough water until the H₂O/(SiO₂+GeO₂) molar ratio was about 10. Then, 15 mmol of HF (48 wt. % reagent) was added dropwise. The liner was then capped, sealed inside the 23-mL autoclave and heated at 160° C. under tumbling conditions (43 rpm) inside a convection oven for 6-9 days. The solid material was recovered afterwards, washed several times with deionized water, and dried at 95° C.

Powder XRD was used to identify the recovered material as CIT-13.

A portion of the recovered CIT-13 material was calcined by heating to 595° C., using a ramped program of 1° C./min, with a 2 hour pause at 120° C. before continuing up to the target temperature and holding it there for 4 hours before the sample was allowed to cool to room temperature.

The powder XRD of the calcined product was consistent with that of CIT-13.

### Example 2

### Synthesis of Aluminum-Containing Phyllosilicate CIT-13P

1 g of the calcined aluminum-containing CIT-13 from Example 1 was heated to 45° C., with 600 rpm stirring, for 24 h in a closed vessel with 15 g of concentrated ammonium hydroxide in 72 mL of water. The solid was recovered by filtration, washed with deionized water, and dried overnight at 95° C. to provide an aluminum-containing phyllosilicate.

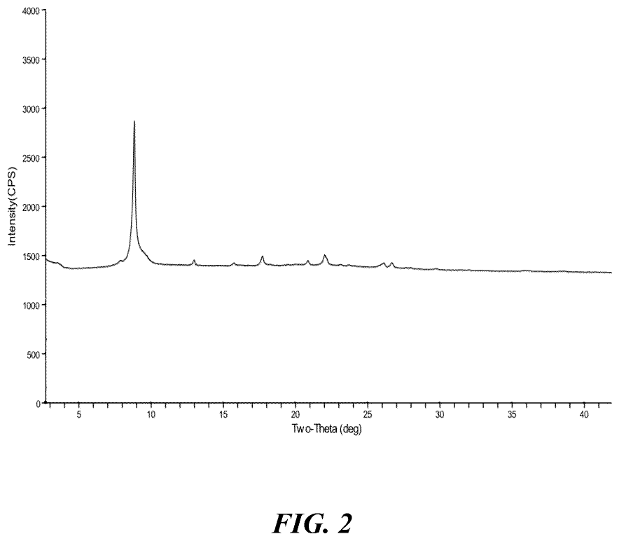

The phyllosilicate was shown by powder XRD to be a poorly crystalline product (see FIG. 2), indicating removal of much of the framework Ge atoms.

### Example 3

### Synthesis of Aluminum-Containing CIT-15 Molecular Sieve

The aluminum-containing phyllosilicate from Example 2 was then heated to 95° C. in a closed container with 4.5 g of n-octylamine for 3 days. The amine-treated layered precursor was worked up by decanting the amine away from the solids. Then the solids were treated with an excess of diethyl ether for a period of several hours with this treatment repeated a second time. The solids product, after removing the second ether treatment, was air dried to remove the last of the ether and then calcined as described in Example 1.

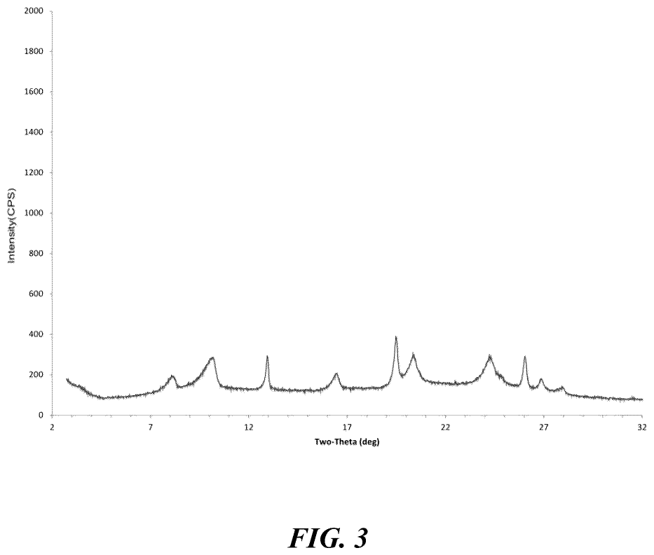

The powder XRD of the product after calcination was consistent with that of CIT-15 (FIG. 3).

Analysis by Inductively Coupled Plasma-Atomic Emission Spectroscopy (ICP-AES) indicated that the product had an aluminum content of 0.82 wt. %.

The resulting aluminum containing CIT-15 product had a total amount of acid sites of 55 mmol H⁺/g, wherein the total amount of acid sites is defined as a total molar amount of desorbed n-propylamine per mass of the molecular sieve material determined according to a temperature programmed desorption of n-propylamine.

The calcined CIT-15 material had a micropore volume (V_{micro}) of 0.041 cm³/g.

### Example 4 (Comparative)

In this Example, the dried aluminum-containing phyllosilicate of Example 2 was calcined directly without treating with n-octylamine.

The powder XRD of the product after calcination was consistent with that of CIT-15.

The calcined CIT-15 material had a micropore volume (V_{micro}) of 0.00 cm³/g.

What is claimed is:

1. A process for preparing an aluminum-containing molecular having a CIT-15 framework structure, the process comprising:
(i) providing a molecular sieve having a CIT-13 framework structure, wherein the framework structure comprises Al₂O₃, GeO₂ and SiO₂, wherein the molecular sieve has a molar ratio of GeO₂:SiO₂ of from 3.8:1 to 5.68:1, the molecular sieve characterized by a three-dimensional framework of silica-rich cfi-layers interconnected by germania-rich double-4-ring (d4r) units and having pores defined by 10- and 14-membered rings;
(ii) treating the molecular sieve provided in (i) with a basic aqueous solution, the treating resulting in delamination of the molecular sieve thereby obtaining an aluminum-containing phyllosilicate comprising delaminated silica-rich cfi-layers wherein the phyllosilicate has a molar ratio of GeO₂:SiO₂ of least 40:1, and at least partially separating the phyllosilicate from the basic aqueous solution;
(iii) treating the separated aluminum-containing phyllosilicate obtained in (ii) with a C6-C12 alkylamine thereby obtaining an amine-treated aluminum-containing phyllosilicate, and at least partially separating the amine-treated aluminum-containing phyllosilicate from the alkylamine; and
(iv) calcining the amine-treated aluminum-containing phyllosilicate obtained in (iii) at a temperature, and for a time, sufficient to form an aluminum-containing molecular sieve having a CIT-15 framework structure, wherein the framework structure comprises Al₂O₃ and SiO₂, the molecular sieve characterized by a three-dimensional framework having pores defined by 10-membered rings.

2. The process of claim 1, wherein the molecular sieve provided in (i) has a SiO₂:Al₂O₃ molar ratio of 50:1 to 500:1.

3. The process of claim 1, the aqueous basic solution comprises a base and has a pH from 8 to 14, and wherein the base is ammonium hydroxide or a tetraalkylammonium hydroxide.

4. The process of claim 1, wherein the treating according to (ii) is carried out at a temperature of 35° C. to 110° C.

5. The process of claim 1, wherein the treating according to (ii) is carried out for a time of 6 to 72 hours.

6. The process of claim 1, wherein the treating according to (ii) is carried out in a closed system.

7. The process of claim 1, wherein the aluminum-containing phyllosilicate obtained in (ii) is not subjected to calcination prior to the treating according to (iii).

8. The process of claim 1, wherein the C6-C12 aklylamine is selected from the group consisting of triethylamine, dipropylamine, hexylamine, heptylamine, octylamine, nonylamine, decylamine, dodecylamine, and mixtures thereof.

9. The process of claim 1, wherein the treating according to (iii) is carried out at a temperature of 50° C. to 125° C.

10. The process of claim 1, wherein the treating according to (iii) is carried out for a time of 1 to 7 days.

11. The process of claim 1, wherein the treating according to (iii) is carried out in a closed system.

12. The process of claim 1, wherein the calcining according (iv) occurs at a temperature of 400° C. to 700° C. and for a time of 1 to 10 hours.

13. The process of claim 1, further comprising (v) loading a promoter metal cation on and/or in the aluminum-containing molecular sieve obtained in (iv).

14. An aluminum-containing molecular sieve having a CIT-15 framework structure obtained according to a process as defined in claim 1.

15. The aluminum-containing molecular sieve of claim 14, which is characterized by one or more of:
(1) a SiO₂:Al₂O₃ molar ratio of 50:1 to 500:1;
(2) a SiO₂:GeO₂ molar ratio of at least 40:1;
(3) a total acid site density of 45 to 75 mmol/g;
(4) a micropore volume of 0.031 to 0.050 cm³/g.
